(19) United States
(12) Patent Application Publication
(10) Pub. No.: US 2013/0067196 A1
(43) Pub. Date: Mar. 14, 2013

(54) VECTORIZATION OF MACHINE LEVEL SCALAR INSTRUCTIONS IN A COMPUTER PROGRAM DURING EXECUTION OF THE COMPUTER PROGRAM

(71) Applicants: Gerald Paul Michalak, Raleigh, NC (US); Charles Dave Estes, Raleigh, NC (US)

(72) Inventors: Gerald Paul Michalak, Raleigh, NC (US); Charles Dave Estes, Raleigh, NC (US)

(73) Assignee: QUALCOMM Incorporated, San Diego, CA (US)

(21) Appl. No.: 13/230,888

(22) Filed: Sep. 13, 2011

(51) Int. Cl. G06F 15/76; G06F 9/06

(52) U.S. Cl. 712/7; 712/E09.003

(57) ABSTRACT

A method of operating a computer processor includes storing at least one machine level vector instruction in a memory and replacing a plurality of machine level scalar instructions in a computer program with the at least one machine level vector instruction during execution of the computer program based on execution addresses associated with the plurality of machine level scalar instructions and/or instruction opcodes associated with the plurality of machine level scalar instructions.

### BACKGROUND

The present disclosure relates generally to vector processors and vector computer program instructions that are executed by vector processors and, more particularly, to replacement of scalar computer program instructions with vector computer program instructions during execution of a computer program.

Multiple types of Central Processing Units (CPUs) can be used in a computer. For example, one type of CPU that can be used is known as a scalar processor. A scalar processor is designed to execute instructions such that each instruction operates on, at most, one data item at a time. Another type of CPU that can be used is known as a vector processor or array processor. A vector processor is designed to execute instructions, known as vector instructions, such that a single vector instruction can operate on multiple data items simultaneously. For example, one vector instruction may be used to add the contents of two individual arrays of data items together. The individual arrays of data items may be called vectors.

To take advantage of the improved performance and data processing efficiency that a vector processor may provide, a compiler is used to generate the machine level vector instructions from the source code of a computer program. If the application is a legacy application, however, the source code of the computer program may not be available. Therefore, even if the legacy application is run on a computer that includes a vector processor, the improved performance of the vector processor may not be fully realized.

### SUMMARY OF THE DISCLOSURE

It should be appreciated that this Summary is provided to introduce a selection of concepts in a simplified form, the concepts being further described below in the Detailed Description. This Summary is not intended to identify key features or essential features of this disclosure, nor is it intended to limit the scope of the disclosure.

Some embodiments of the inventive subject matter provide a method of operating a computer processor. The method comprises storing at least one machine level vector instruction in a memory and replacing a plurality of machine level scalar instructions in a computer program with the at least one machine level vector instruction during execution of the computer program based on execution addresses associated with the plurality of machine level scalar instructions and/or instruction opcodes associated with the plurality of machine level scalar instructions.

In other embodiments, the method further comprises detecting a code segment in the computer program comprising a loop. Replacing the plurality of machine level scalar instructions comprises replacing the plurality of machine level scalar instructions in the detected code segment in the computer program comprising the loop with the at least one machine level vector instruction.

In still other embodiments, detecting the code segment in the computer program comprising the loop comprises determining that the code segment in the computer program comprising the loop begins at a memory location corresponding to a target memory location of a conditional branch instruction.

In still other embodiments, the code segment in the computer program comprising the loop ends with the conditional branch instruction and contains no other branch instructions.

In still other embodiments, detecting the code segment in the computer program comprising the loop comprises determining a loop counter value.

In still other embodiments, the at least one machine level vector instruction comprises at least one N lane vector instruction. Replacing the plurality of machine level scalar instructions in the computer program with the at least one machine level vector instruction comprises replacing the plurality of machine level scalar instructions in the computer program with the at least one N lane vector instruction until a remaining number of loop iterations is less than N based on the loop counter value.

In still other embodiments, the code segment is a first code segment and the loop is a first loop. The method further comprises detecting a second code segment in the computer program comprising a second loop. Replacing the plurality of machine level scalar instructions comprises replacing the plurality of machine level scalar instructions in the detected second code segment in the computer program comprising the second loop with the at least one machine level vector instruction and the first loop is in the second loop.

In still other embodiments, the method further comprises detecting a compiler marker that identifies the plurality of machine level scalar instructions in the computer program.

In still other embodiments, the method further comprises detecting a repeated code segment in the computer program. Replacing the plurality of machine level scalar instructions comprises replacing the plurality of machine level scalar instructions in the repeated code segment in the computer program with the at least one machine level vector instruction.

In still other embodiments, the method further comprises executing the computer program and determining at least one code segment in the computer program where operand data can be pipelined based on the computer program execution. Replacing the plurality of machine level scalar instructions comprises replacing the at least one code segment with the at least one machine level vector instruction.

In still other embodiments, the method further comprises evaluating execution time for the at least one code segment and/or power used in executing the at least one code segment. Replacing the at least one code segment with the at least one machine level vector instruction comprises replacing the at least one code segment with the at least one machine level vector instruction based on the execution time for the at least one code segment and/or power used in executing the at least one code segment.

In still other embodiments, the method further comprises evaluating execution time for at least a portion of the computer program and/or power used in executing the at least the portion of the computer program. Replacing the plurality of machine level scalar instructions with the at least one machine level vector instruction comprises replacing the at least the portion of the computer program with the at least one machine level vector instruction responsive to the evaluated execution time for the at least the portion of the computer program and/or the power used in executing the at least the portion of the computer program.

In still other embodiments, replacing the plurality of machine level scalar instructions in the computer program with the at least one machine level vector instruction comprises replacing the plurality of machine level scalar instructions with at least one prologue machine level vector instruction that precedes the at least one machine level vector instruction and at least one epilogue machine level vector instruction that follows the at least one machine level vector instruction.

In still other embodiments, the at least one prologue machine level vector instruction is configured to set up at least one data item in a location for use by the at least one machine level vector instruction.

In still other embodiments, the at least one epilogue machine level vector instruction is configured to set up at least one data item in a location for use by machine level scalar instructions in the computer program that have not been replaced by the at least one machine level vector instruction.

Some further embodiments of the inventive subject matter provide a computer program vectorization machine. The computer program vectorization machine comprises a memory having at least one machine level vector instruction stored in the memory and a processor that is configured to replace a plurality of machine level scalar instructions in a computer program with the at least one machine level vector instruction during execution of the computer program based on execution addresses associated with the plurality of machine level scalar instructions and/or instruction opcodes associated with the at least one machine level vector instruction.

In still further embodiments, the processor is further configured to detect a code segment in the computer program comprising a loop. The processor is configured to replace the plurality of machine level scalar instructions in the computer program with the at least one machine level vector instruction by replacing the plurality of machine level scalar instructions in the detected code segment in the computer program comprising the loop with the at least one machine level vector instruction.

In still further embodiments, the processor is further configured to replace the plurality of machine level scalar instructions in the computer program with the at least one machine level vector instruction by replacing the plurality of machine level scalar instructions with at least one prologue machine level vector instruction that precedes the at least one machine level vector instruction and at least one epilogue machine level vector instruction that follows the at least one machine level vector instruction.

In still further embodiments, the at least one prologue machine level vector instruction is configured to set up at least one data item in a location for use by the at least one machine level vector instruction.

In still further embodiments, the at least one epilogue machine level vector instruction is configured to setup at least one data item in a location for use by machine level scalar instructions in the computer program that have not been replaced by the at least one machine level vector instruction.

Some embodiments of the inventive subject matter may allow a legacy software application to take advantage of performance improvements that may be provided by a vector processor without being re-compiled for the vector processor through the replacement of one or more scalar instructions from the legacy software application with one or more vector instructions.

Other methods and apparatus according to embodiments of the inventive subject matter will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

FIG. 1 is a block diagram of an instruction pipeline for a vector processor that includes a vectorization machine.

FIG. 2 is a block diagram of a computer program that includes a loop code segment.

FIG. 3 is an example of a computer program that illustrates the generation of machine level vector instructions to be used to replace machine level scalar instructions that implement a loop code segment in the computer program.

### DETAILED DESCRIPTION

While the inventive subject matter is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims. Like reference numbers signify like elements throughout the description of the figures.

As used herein, the singular forms “a,” “an,” and “the” are intended to include the plural forms as well, unless expressly stated otherwise, It should be further understood that the terms “comprises” and/or “comprising” when used in this specification is taken to specify the presence of stated features, integers, steps, operations, elements, and/or components, but does not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Some embodiments of the inventive subject matter described herein are based on the concept of replacing machine level scalar instructions in a computer program with one or more machine level vector instructions during execution of the computer program. For example, the machine level vector instructions may be stored in a memory, such as a cache, and, based the execution addresses associated with the machine level scalar instructions and/or instruction opcodes associated with the machine level scalar instructions, the machine level vector instructions can be retrieved from the cache to replace the machine level scalar instructions during execution as opposed to doing such a replacement during program compilation or by using a pre-processor to operate on the executable object.

One type of program code segment that may be vectorized (i.e., machine level scalar instructions replaced with one or more machine level vector instructions) is a program loop. The beginning of a loop code segment may be determined by identifying the target address of a conditional branch instruction and verifying that there are no other branch instructions between the beginning of the loop code segment and the conditional branch instruction.

Depending on the number of loop iterations, a compiler may implement a loop by generating series of repeated code segments. This may be called “unrolling the loop,” Such repeated code segments may also be detected and vectorized.

A loop counter value can be obtained from a register, for example, and used to determine when to replace the machine level scalar instructions with the machine level vector instructions. For example, if N lane vector instructions are used, the machine level scalar instructions can be replaced with the machine level vector instructions until a remaining number of loop cycles is less than N, which can be determined based on the loop counter value. In addition to vectorizing a stand-alone program loop, it may also be possible to vectorize software structures in which one or more loops are nested within each other.

While in some embodiments of the inventive subject matter the program code segment to be vectorized may be analyzed through execution to detect a loop structure, for example, in other embodiments the compiler may place a marker in the code that identifies a code segment as being a candidate for vectorization.

Code segment candidates for vectorization may also be determined by executing the computer program and doing an analysis of the execution patterns to determine code segments where operand data can be pipelined.

Other factors may also be taken into consideration for making a decision whether or not to vectorize a code segment. For example, the processor execution time and/or the power used in executing the code segment may be used as a basis for determining whether to vectorize the code segment.

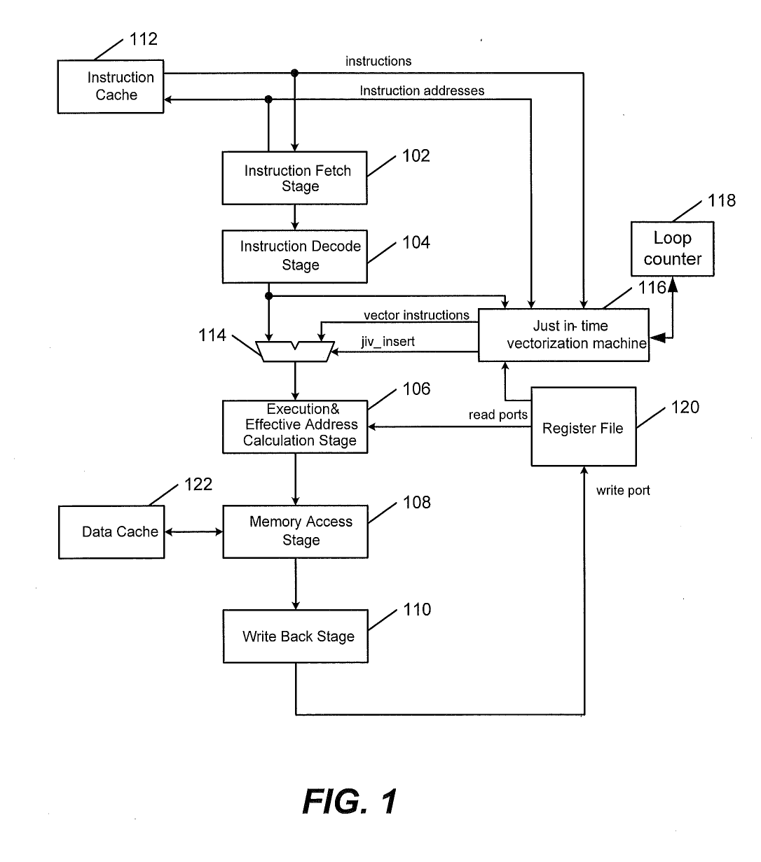

Referring to FIG. 1, an instruction pipeline for a vector processor that includes a vectorization machine, according to some embodiments of the present inventive subject matter is shown. An instruction pipeline is a technique that allows a processor to increase its instruction throughput. The general idea is to split the processing of a computer instruction into a series of independent steps or stages. In the example shown in FIG. 1, the instruction pipeline includes five stages: an instruction fetch stage 102, an instruction decode stage 104, an execution stage 106, a memory access stage 108, and a register write back stage 110. It will be understood that instruction pipelines may include more or fewer stages than that shown in FIG. 1 in accordance with various embodiments of the inventive subject matter. A deeper pipeline means that there are more stages in the pipeline with fewer logic gates in each stage. As a result, the processor's frequency can be increased due to fewer components in each stage of the pipeline. This may allow the propagation delay for the overall stage to be reduced.

The five stage pipeline of FIG. 1 further includes an instruction cache 112, a multiplexer 114, a vectorization machine 116, a loop counter 118, a register file 120, and a data cache 122 that are connected as shown. Exemplary operations of the pipelined processor of FIG. 1 that includes the vectorization machine 116 will now be described. The instruction fetch stage 102 fetches a machine level scalar instruction from the instruction cache 112 based on the contents of a program counter. The fetched instruction is decoded in the instruction decode stage 104. The decoding may involve, for example, identifying any register inputs and, if the fetched instruction is a branch or jump instruction, computing the target address for the branch or jump operation.

In a conventional five stage pipeline architecture, the instruction decode stage 104 is coupled directly to the execution stage 106. In accordance with some embodiments of the present inventive subject matter, a multiplexer 114 is disposed between the instruction decode stage 104 and the execution stage 106 to allow for the replacement of one or more machine level scalar instructions with one or more machine level vector instructions generated by the vectorization machine 116. The vectorization machine 116 may generate a “jiv_insert” signal to control whether the decoded machine level scalar instructions are passed from the instruction decode stage 104 to the execution stage 106 or whether the machine level vector instructions are passed front the vectorization machine 116 to the execution stage 106.

The execution stage 106 accepts the instructions output from the multiplexer 114 and performs the operations including calculating any virtual addresses for operations involving memory references. In some embodiments, execution of the instructions can be categorized based on the latency involved with the operation. For example, register to register operations, such as add, subtract, compare, and logical operations may fall into a single cycle latency class. Memory reference operations may fall into a two cycle latency class, Multiplication, divide, and floating-point operations may fall into a many cycle latency class.

At the memory access stage 108, single cycle latency instructions have their results forwarded to the write back stage 110. If, however, the instruction involves a load from memory, the data is read from the data cache 122. The data cache 122 may be designed in accordance with a variety of different architectures in accordance with various embodiments of the present inventive subject matter.

At the write back stage 110, the results from the execution of the instructions are written to the register file 120. In some embodiments of the present inventive subject matter, instructions that fall into the many cycle latency class may write their results to a separate set of registers to allow the pipeline to continue processing instructions while a multiplication/divide unit performs multi-cycle operation.

As described above, the vectorization machine 116 may generate machine level vector instructions to replace machine level scalar instructions at run time so as to allow, for example, a legacy computer program that has been compiled for a scalar processor to take advantage of the efficiency and improved performance of a vector processor even if the source code for the legacy computer program is no longer available for the program to be re-compiled for the vector processor. Thus, the vectorization machine 116 may be termed a just-in-time vectorization machine 116 as the machine level vector instructions are substituted for the machine level scalar instructions at run time of the computer program.

In some embodiments of the inventive subject matter, the vectorization machine 116 analyzes the machine level scalar instructions comprising the computer program during execution to determine whether any of the machine level scalar instructions or groups of machine level scalar instructions are good candidates for replacement by machine level vector instructions. For any machine level scalar instructions identified as targets for replacement, the machine level vector instructions generated by the vectorization machine 116 to replace the identified machine level scalar instructions can be stored in a memory, such as, for example, the instruction cache 112. The vectorization machine 116 may retrieve the stored machine level vector instructions from the memory and replace the machine level scalar instructions through the multiplexer 114 during execution based on one or more execution addresses associated with the machine level scalar instructions and/or instruction opcodes associated with the machine level scalar instructions.

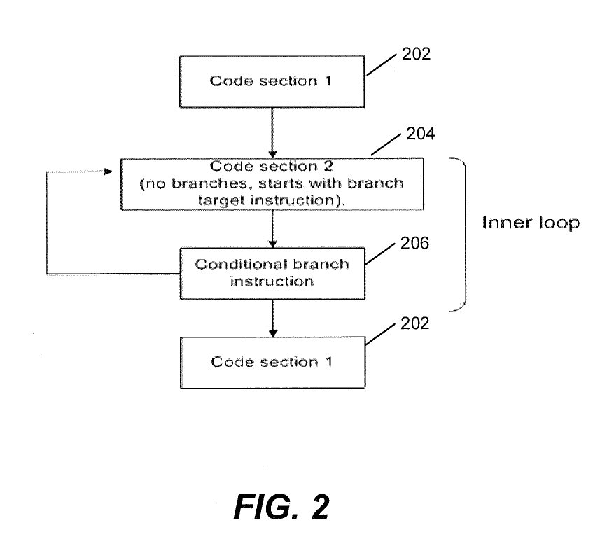

One type of code segment that may be a candidate for implementation using vector program instructions is a loop. FIG. 2 is a block diagram of a computer program that includes a loop code segment according to some embodiments of the inventive subject matter. The computer program includes a first code section 202 that includes a second code section 204 and 206 that comprise an inner loop. According to some embodiments of the present inventive subject matter, the beginning of the loop 204 can be identified as a memory location that corresponds to a target memory location of a conditional branch instruction, which corresponds to the end of the loop 206. The vectorization machine 116 can determine that the second code segment 204 and 206 comprise a loop based on the second code segment ending with a single conditional branch instruction and containing no other branch instructions.

To generate the machine level vector instructions to replace a loop code segment of machine level scalar instructions, the vectorization machine 116 may use machine level vector instructions that act on N pairs of data elements at a time, for example. These machine level vector instructions may be termed “N lane” vector instructions. The vectorization machine 116 may use the loop counter 218 to time when to replace one or more machine level scalar instructions comprising a loop code segment with one or more N lane machine level vector instructions. In some embodiments of the inventive subject matter, the vectorization machine 116 obtains a loop counter value from the loop counter 218. The vectorization machine 116 monitors a difference between the total number of loops in the loop code segment with the loop counter value and, through use of the signal “jiv_insert,” replaces the machine level scalar instruction(s) comprising the loop code segment with the one or more N lane machine level vector instructions until the number of remaining iterations in the loop is less than N through the multiplexer 214.

Computer programs sometimes use multiple loops nested within each other. The machine level scalar instructions comprising each of these loops may be candidates for replacement with machine level vector instructions as described above. The vectorization machine 216 may use the techniques described above for a single loop to replace the machine level scalar instructions making up each loop in a nested structure with machine level vector instructions.

A software compiler may compile source code that includes a loop into machine level scalar instructions that are organized into repeated code segments. This is sometimes called “unrolling the loop,” The vectorization machine 116 may analyze the machine level scalar instructions of a computer program as they are being executed and detect instances of a repeated code segment. The repeated code segment may then be replaced by one or more machine level vector instructions generated by the vectorization machine 116 in one or more instances thereof as described above.

Embodiments of the present inventive subject matter have been described above with reference to replacing machine level scalar instructions comprising a loop or repeated code segment with one or more machine level vector instructions during execution of the machine level scalar instructions. While a loop is one particular type of software construct that may be conductive to implementation via machine level vector instructions, it will be understood that, in general, machine level scalar instruction code segments where operand data can be pipelined may be candidates for replacement with one or more machine level vector instructions generated by the vectorization machine 116. The vectorization machine 216, therefore, may do an analysis of the execution patterns to determine code segments where operand data can be pipelined and generate machine level vector instructions for these determined code segments that can be used to replace the machine level scalar instructions comprising these determined code segments as described above.

To reduce the burden on the vectorization machine 116 in identifying machine level scalar instructions that may be candidates for replacement by machine level vector instructions, a compiler may be used to insert a marker or some type of identifier in the compiled code that can identify locations in the machine level source code of code segments that are structured in such a way so as to be conducive to replacement by machine level vector instructions according to sonic embodiments of the inventive subject matter.

Other techniques may be used to identify code segments in a computer program that may be candidates for vectorization in accordance with various embodiments of the present invention. For example, the vectorization machine 116 may analyze execution of a computer program to determine the execution time associated with various segments of the program. Code segments that are associated with higher levels of execution time may be candidates for replacement of the machine level scalar instructions comprising such code segments with machine level vector instructions to take advantage of the increased processing efficiency of the vector processor. In other embodiments, the vectorization machine 116 may analyze execution of a computer program to determine the power used in executing various segments of the program. Code segments that are associated with higher levels of power consumption may be candidates for replacement of the machine level scalar instructions comprising such code segments with machine level vector instructions to take advantage of the increased processing efficiency of the vector processor and potentially reduce the power consumed in executing the program.

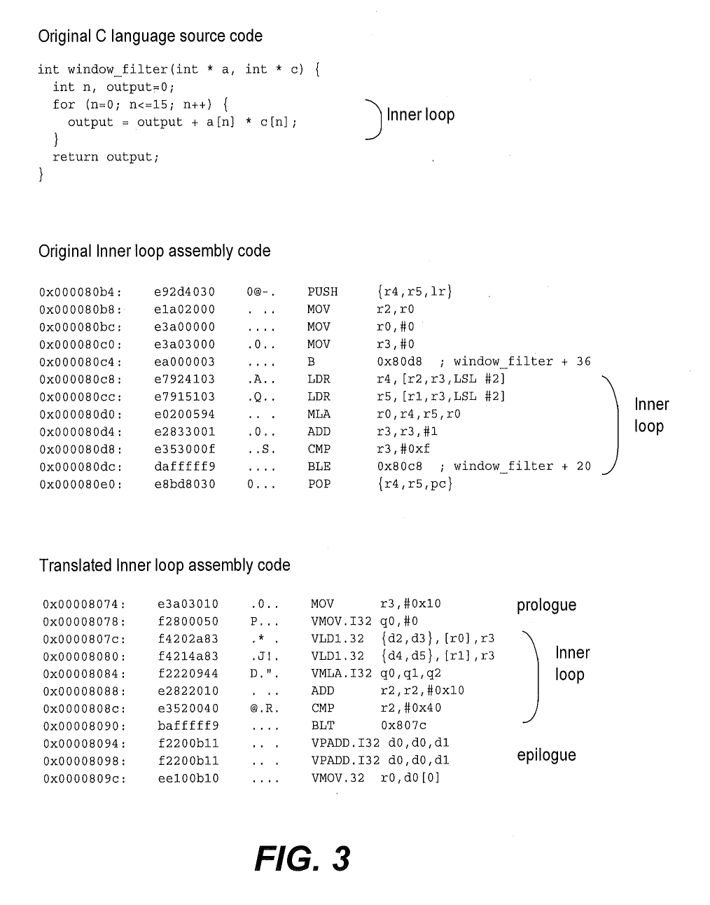

FIG. 3 is an example that illustrates the generation of machine level vector instructions to be used to replace machine level scalar instructions that implement a loop code segment according to some embodiments of the inventive subject matter. As shown in FIG. 3, a C language program includes a function named window_filter that includes an inner loop, The program is compiled to generate assembly code as shown in FIG. 3. The inner loop portion of the window Jitter function comprises the scalar assembly instructions from addresses 0x000080c8 through 0x000080dc. The vectorization machine 116 is configured to generate the vector inner loop assembly code shown in FIG. 3 that can replace the scalar inner loop assembly code generated by the compiler. As shown in FIG. 3, the generated vector inner loop assembly code includes prologue instructions at addresses 0x00008074 and 0x00008078 and epilogue instructions at addresses 0x00008094 through 0x0000809c. The prologue and epilogue instructions may be used to provide an interface for the vector instructions and the scalar instructions. That is, the vector instructions and scalar instructions may use registers differently, may require different setup conditions for particular instructions, and may generate computational results differently. The epilogue and prologue instructions may account for such differences between the scalar instructions and the vector instructions. For example, a prologue instruction may be used to setup at least one data item in a location for use by one or more of the vector instructions. Similarly, an epilogue instruction may be used to setup at least one data item in a location for use by one or more scalar instructions that were not replaced by the vector instructions.

Some embodiments of the inventive subject matter provide a vector processor that includes a vectorization machine 116 that analyzes execution of a computer program that was compiled, for example, for execution on a scalar processor, and determines whether any of the machine level scalar instructions, groups, or code segments are conductive for replacement by machine level vector instructions. Once the vectorization machine 116 generates machine level vector instructions to replace a particular code segment, the generated machine level vector instructions may be stored in memory, such as a cache memory, buffer, or the like for retrieval when the computer program reaches the addresses of the particular code segment or segments being replaced. This alleviates the need for the vectorization machine 16 to regenerate machine level vector instructions to replace machine level scalar instructions every time particular code segments are executed. The vectorization machine 116 may also use instruction opcodes to identify the code segments to be replaced with the machine level vector instructions stored in memory.

A generally large percentage of computer programs being executed today on vector processors do not contain vector instructions because they were compiled for execution on a scalar processor. The embodiments described above may reduce the execution time and potentially the energy consumption of such programs through replacement of one or more code segments during execution with machine level vector instructions that can take advantage of the benefits of a vector processor. Moreover, the computer programs may be modified without the need to obtain the original source code and perform a recompilation.

Many variations and modifications can be made to the embodiments without substantially departing from the principles of the present invention. All such variations and modifications are intended to be included herein within the scope of the present invention, as set forth in the following claims.

That which is claimed:

1. A method of operating a computer processor, comprising:
storing at least one machine level vector instruction in a memory; and
replacing a plurality of machine level scalar instructions in a computer program with the at least one machine level vector instruction during execution of the computer program based on execution addresses associated with the plurality of machine level scalar instructions and/or instruction opcodes associated with the plurality of machine level scalar instructions.

2. The method of claim 1, further comprising:
detecting a code segment in the computer program comprising a loop;
wherein replacing the plurality of machine level scalar instructions comprises replacing the plurality of machine level scalar instructions in the detected code segment in the computer program comprising the loop with the at least one machine level vector instruction.

3. The method of claim 2, wherein detecting the code segment in the computer program comprising the loop comprises:
determining that the code segment in the computer program comprising the loop begins at a memory location corresponding to a target memory location of a conditional branch instruction.

4. The method of claim 3, wherein the code segment in the computer program comprising the loop ends with the conditional branch instruction and contains no other branch instructions.

5. The method of claim 3, wherein detecting the code segment in the computer program comprising the loop comprises:
determining a loop counter value.

6. The method of claim 5, wherein the at least one machine level vector instruction comprises at least one N lane vector instruction and wherein replacing the plurality of machine level scalar instructions in the computer program with the at least one machine level vector instruction comprises:
replacing the plurality of machine level scalar instructions in the computer program with the at least one N lane vector instruction until a remaining number of loop iterations is less than N based on the loop counter value.

7. The method of claim 2, wherein the code segment is a first code segment and the loop is a first loop, the method further comprising:
detecting a second code segment in the computer program comprising a second loop;
wherein replacing the plurality of machine level scalar instructions comprises replacing the plurality of machine level scalar instructions in the detected second code segment in the computer program comprising the second loop with the at least one machine level vector instruction; and
wherein the first loop is in the second loop.

8. The method of claim 1, further comprising:
detecting a compiler marker that identifies the plurality of machine level scalar instructions in the computer program.

9. The method of claim 1, further comprising:
detecting a repeated code segment in the computer program;
wherein replacing the plurality of machine level scalar instructions comprises replacing the plurality of machine level scalar instructions in the repeated code segment in the computer program with the at least one machine level vector instruction.

10. The method of claim 1, further comprising:
executing the computer program; and
determining at least one code segment in the computer program where operand data can be pipelined based on the computer program execution;
wherein replacing the plurality of machine level scalar instructions comprises replacing the at least one code segment with the at least one machine level vector instruction.

11. The method of claim 10, further comprising:
evaluating execution time for the at least one code segment and/or power used in executing the at least one code segment;
wherein replacing the at least one code segment with the at least one machine level vector instruction comprises replacing the at least one code segment with the at least one machine level vector instruction based on the execution time for the at least one code segment and/or power used in executing the at least one code segment.

12. The method of claim 1, further comprising:
evaluating execution time for at least a portion of the computer program and/or power used in executing the at least the portion of the computer program;
wherein replacing the plurality of machine level scalar instructions with the at least one machine level vector instruction comprises replacing the at least the portion of the computer program with the at least one machine level vector instruction responsive to the evaluated execution time for the at least the portion of the computer program and/or the power used in executing the at least the portion of the computer program.

13. The method of claim 1, wherein replacing the plurality of machine level scalar instructions in the computer program with the at least one machine level vector instruction comprises replacing the plurality of machine level scalar instructions with at least one prologue machine level vector instruction that precedes the at least one machine level vector instruction and at least one epilogue machine level vector instruction that follows the at least one machine level vector instruction.

14. The method of claim 13, wherein the at least one prologue machine level vector instruction is configured to set up at least one data item in a location for use by the at least one machine level vector instruction.

15. The method of claim 13, wherein the at least one epilogue machine level vector instruction is configured to set up at least one data item in a location for use by machine level scalar instructions in the computer program that have not been replaced by the at least one machine level vector instruction.

16. A computer program vectorization machine, comprising:
a memory having at least one machine level vector instruction stored in the memory; and
a processor that is configured to replace a plurality of machine level scalar instructions in a computer program with the at least one machine level vector instruction during execution of the computer program based on execution addresses associated with the plurality of machine level scalar instructions and/or instruction opcodes associated with the at least one machine level vector instruction.

17. The computer program vectorization machine of claim 16, wherein the processor is further configured to detect a code segment in the computer program comprising a loop, and wherein the processor is configured to replace the plurality of machine level scalar instructions in the computer program with the at least one machine level vector instruction by replacing the plurality of machine level scalar instructions in the detected code segment in the computer program comprising the loop with the at least one machine level vector instruction.

18. The computer program vectorization machine of claim 16, wherein the processor is further configured to replace the plurality of machine level scalar instructions in the computer program with the at least one machine level vector instruction by replacing the plurality of machine level scalar instructions with at least one prologue machine level vector instruction that precedes the at least one machine level vector instruction and at least one epilogue machine level vector instruction that follows the at least one machine level vector instruction.

19. The method of claim 18, wherein the at least one prologue machine level vector instruction is configured to set up at least one data item in a location for use by the at least one machine level vector instruction.

20. The method of claim 18, wherein the at least one epilogue machine level vector instruction is configured to setup at least one data item in a location for use by machine level scalar instructions in the computer program that have not been replaced by the at least one machine level vector instruction.
